(19) United States
(12) Patent Application Publication
(10) Pub. No.: US 2022/0258771 A1
(43) Pub. Date: Aug. 18, 2022

(54) METHOD TO DETECT DRIVER READINESS FOR VEHICLE TAKEOVER REQUESTS

(71) Applicant: Veoneer US, Inc., Southfield, MI (US)

(72) Inventors: Caroline Chung, Royal Oak, MI (US); Thomas J. Herbert, Fenton, MI (US); Francis J. Judge, South Lyon, MI (US)

(73) Assignee: Veoneer US, Inc., Southfield, MI (US)

(21) Appl. No.: 17/620,610

(22) PCT Filed: Jun. 18, 2020
(86) PCT No.: PCT/US2020/038364

§ 371 Date: Dec. 17, 2021

Related U.S. Application Data
(60) Provisional application No. 62/863,128, filed on Jun. 18, 2019.

(51) Int. Cl. B60W 60/00; B60W 40/08; G06V 20/59; B60W 50/14

(52) U.S. Cl. CPC B60W 60/0053; B60W 40/08; G06V 20/597; B60W 50/14; B60W 2050/143; B60W 2540/225; B60W 2540/221; B60W 2540/229; B60W 2420/42

(57) ABSTRACT

A monitoring system for determining driver readiness for takeover of vehicle control from an autonomous driving system is provided. The monitoring system may include an evaluation processor and a driver monitoring system. The evaluation processor may access driver data from the driver monitoring system. The driver monitoring system may include one or more driver monitoring sensors that capture attributes of the driver indicative of driver ability to take over vehicle control. The evaluation processor may prompt the driver for an affirmative confirmation of takeover in response to a takeover request from an autonomous driving system and the sensed attributes of the driver indicative of the driver being ready to take over vehicle control.

### CROSS-REFERENCE TO RELATED APPLICATION

The present application claims the benefit of the filing date of U.S. Provisional Application No. 62/863,128, filed Jun. 18, 2019, the disclosure of which is hereby incorporated herein by reference in its entirety.

BACKGROUND

### FIELD OF THE INVENTION

The present application generally relates to a monitoring system for determining driver readiness for takeover of vehicle control from an autonomous driving system

### SUMMARY

A monitoring system for determining driver readiness for takeover vehicle control from an autonomous driving system is provided. The monitoring system comprises a driver monitoring system that includes at least one driver monitoring sensor configured to capture an attribute of the driver indicative of driver ability to take over vehicle control. The monitoring system also comprises an evaluation processor configured to access driver data from the driver monitoring system and to determine driver ability to take over vehicle control using the driver data from the driver monitoring system.

A method for determining driver readiness for takeover vehicle control from an autonomous driving system is also provided. The method comprises: capturing, by at least one driver monitoring sensor, an attribute of the driver indicative of driver ability to take over vehicle control; generating, by a driver monitoring system, driver data using sensor data from the at least one driver monitoring sensor; and determining, by an evaluation processor, driver ability to take over vehicle control using the driver data from the driver monitoring system.

Further objects, features, and advantages of this application will become readily apparent to persons skilled in the art after a review of the following description, with reference to the drawings and claims that are appended to and form a part of this specification.

### BRIEF DESCRIPTION OF THE DRAWINGS

FIG. 1 is a schematic diagram for a driver monitor.

FIG. 2A is a schematic diagram of a vehicle with sensors for monitoring the driver and outside environmental attributes.

FIG. 2B is a schematic diagram of a vehicle illustrating a communication and alert system.

FIG. 3 is a block diagram illustrating a method for monitoring driver readiness and executing takeover.

### DETAILED DESCRIPTION

Level 2 and 3 semi-autonomous vehicles cannot drive in all conditions and scenarios and in certain circumstances require a driver takeover control of the vehicle. No current technology in the market addresses whether the driver is ready to take over and how to re-engage the driver sufficiently. The disclosed system determines if the driver is prepared and ready to take over based on inputs such as driver gaze, impairment, cognitive load, etc. A secondary confirmation could include a constantly changing system of tasks that the driver would be asked to perform to confirm that they are “back in the loop” and paying attention.

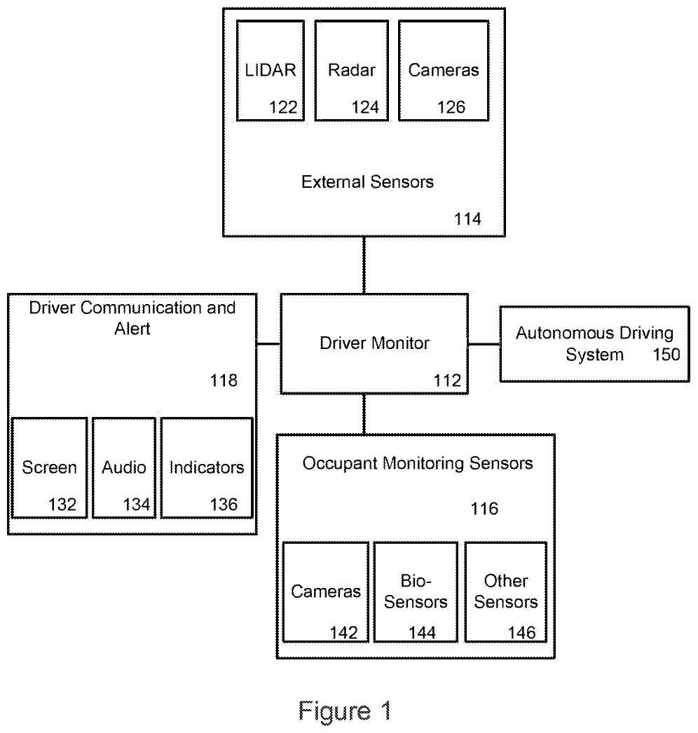

FIG. 1 is a schematic view of a driver monitor 112. The driver monitor may determine a driver profile and driver baseline as described elsewhere in this application. In accomplishing these tasks, the driver monitor 112 may be in communication with external sensors 114. The external sensors may monitor the environment surrounding the vehicle as the vehicle is stopped or as the vehicle proceeds along its route. The external sensors may include Lidar 122, radar 124, and cameras 126. However, it is understood that other external sensing technologies may be used, for example, ultrasonic sensors or other distance or environmental measuring sensors within the vehicle. In some examples, the sensors may include temperature sensors, moisture sensors, as well as, various features that may be derived from sensors such as the camera. These features may include whether there is a snowy condition, the amount of glare from the sun, or other external environmental conditions. The driver monitor system 112 may use input from the external sensors 114 to provide environmental context to the driver monitor 112 when determining the vehicle profile and/or baseline. The driver monitor 112 may also be in communication with an occupant monitoring sensors system 116. The occupant monitoring system 116 may include one or more cameras 142, biosensors 144, and/or other sensors 146. The cameras 142 may be mounted in different positions, orientations, or directions within the vehicle to provide different viewpoints of occupants in the vehicle.

In some embodiments, one or more of the cameras 142 are positioned such that the driver is in a field of view of the camera.

The one or more cameras 142 may be used to analyze gestures by the occupants or determine the positon and/or orientation of the occupant, or monitor indications of the occupant such as facial features indicative of emotion or condition. The biosensors 144 may include touch sensors for example, to determine if the driver is touching a certain control such as the steering wheel or gear shift. The biosensors 144 could include a heart rate monitor to determine the heart rate of the passenger, as well as, other biological indications such as temperature or skin moisture. In addition, other sensors 146 may be used such as presence, absence or position sensors to determine for example, if the occupant is wearing a safety belt, a weight sensor to determine the weight of the occupant. The driver monitor 112 may use the occupant monitoring data from the occupant monitoring sensor systems to determine the driver profile and/or baseline.

The driver monitor 112 may also be in communication with a driver communication and alert system 118. The driver communication and alert system 118 may include video screens 132, audio system 134, as well as other indicators 136. The screen may be a screen in the console and may be part of the instrument cluster, or a part of a vehicle infotainment system. The audio may be integrated into the vehicle infotainment system or a separate audio feature for example, as part of the navigation or telecommunication systems. The audio may provide noises such as beeps, chirps or chimes or may provide language prompts for example, asking questions or providing statements in an automated or pre-recorded voice. The driver communication and alert system 118 may also include other indicators for example, lamps or LEDs to provide a visual indication or stimulation either on the instrument cluster or elsewhere in the vehicle including for example, on the side view mirrors or rear view mirror.

The driver monitor 112 may also be in communication with an autonomous driving system 150. The autonomous driving system 150 may utilize the driver profile and driver baseline information for making various decisions for example, when and how to provide vehicle control handoff, when making decisions about drivers and objects (e.g. people, vehicles, etc.) around the current vehicle. In one example, a vehicle-to-vehicle communication system may provide information about a driver in a nearby car based on the driver information system and the autonomous driving system 150 may make driving decisions based on the driver profile and/or driver baseline of drivers in surrounding vehicles.

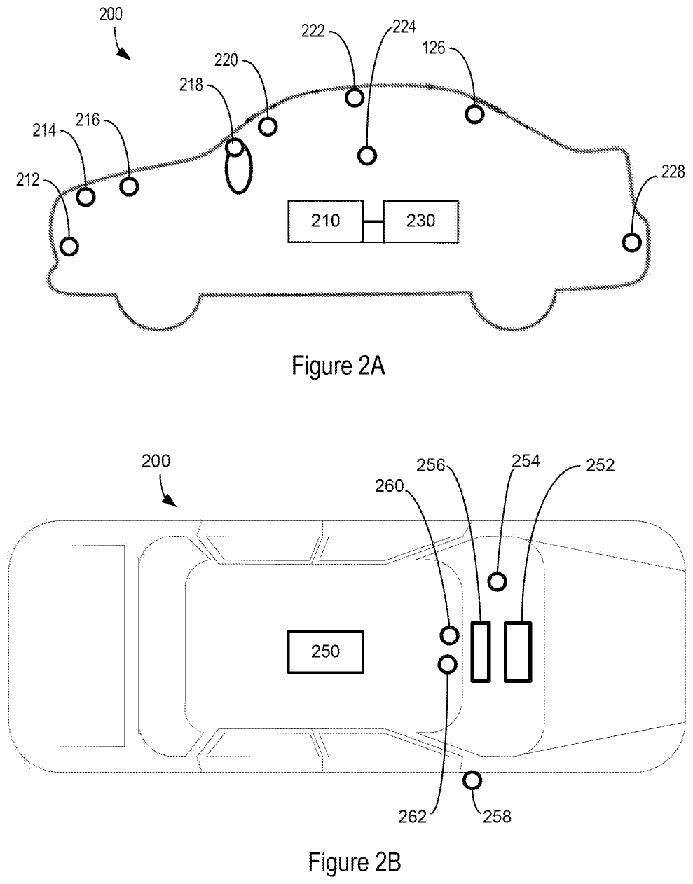

Now referring to FIG. 2, a schematic view of the vehicle 200 is provided. The vehicle may include a sensor processer 210. The sensor processer 210 may include one or more processors to monitor and/or measure the input from various vehicle sensors both inside or outside of the vehicle. For example, as described previously, the vehicle may include a range sensor 212, for example, an ultrasonic sensor to determine if an object is directly from another vehicle 200. The vehicle may include a radar sensor 214. The radar sensor 214 may be a forward looking radar sensor and provide distance and location information of objects that are located within the radar sensing field. As such, a vehicle may include a forward facing radar shown as radar 214. However, a rearward or sideward looking radar may also be included. The system may include a Lidar 216. The Lidar 216 may provide distance and location information for vehicles that are within the sensing field of the Lidar system. As such, the vehicle may include a forward looking Lidar system as shown with regard to Lidar 216. However, rearward or sideward looking Lidar systems may also be provided.

The vehicle 200 may also include biosensors 218. The biosensor 218 may for example, be integrated into a steering wheel of the vehicle. However, other implementations may include integration into seats and/or a seatbelt or within other vehicle controls such as the gear shift or other control knobs. Biosensor 218 may determine a heartbeat, temperature, and/or moisture of the skin of the driver of the vehicle. As such, the condition of the driver may be evaluated by measuring various biosensor readings as provided by the biosensor 218. The system may also have one or more inward or cabin facing cameras 220. The cabin facing cameras 220 may include cameras that operate in the white light spectrum, infrared spectrum, or other available wavelengths. The cameras may be used to determine various gestures of the driver, position or orientation of the driver, or facial expressions of the driver to provide information about the condition of the driver (e.g. emotional state, engagement, drowsiness and impairment of the driver). Further, bioanalysis may be applied to the images from the camera to determine the condition of the driver or if the driver has experienced some symptoms of some medical state. For example, if the driver's eyes are dilated, this may be indicative of a potential medical condition which could be taken into account in controlling the vehicle. As, such, condition of the driver may be determined based on a combination of measurements from one or more sensors. For example, a heart rate in a certain range, a particular facial expression, and skin coloring within a certain range may correspond to a particular emotional state, engagement, drowsiness and/or impairment of the driver.

Cameras 222 may be used to view the external road conditions, such as in front of, behind, or to the side of the vehicle. This may be used to determine the path of the road in front of the vehicle, the lane indications on the road, the condition of the road with regard to road surface, or with regard to the environment external to the vehicle including whether the vehicle is in a rain or snow environment, as well as, lighting conditions external to the vehicle including whether there is glare or glint from the sun or other objects surrounding the vehicle as well as the lack of light due to poor road lighting infrastructure. As discussed previously, the vehicle may include rearward or sideward looking implementations of any of the previously mentioned sensors. As such, a side view mirror sensor 224 may be attached to the side view mirror of the vehicle and may include a radar, Lidar and/or camera sensor for determining external conditions relative to the vehicle including the position of objects such as other vehicles around the instant vehicle. Additionally, rearward facing camera 226 and ultrasonic sensor 228 in the rear bumper of the vehicle provide other exemplary implementations of rearward facing sensors that parallel the functionality of the forward facing sensors described previously.

The vehicle may also include an evaluation processor 230 configured to access driver data from the driver monitoring system and to determine driver ability to take over vehicle control using the driver data from the driver monitoring system. For example, the evaluation processor 230 may be in functional communication with the sensor processer 210. In some embodiments, the evaluation processor 230 may be a stand-alone unit. In some other embodiments, the evaluation processor 230 may be implemented integrally with one or more other processors, such as sensor processer 210.

With regard to FIG. 2B, a vehicle 200 may include a vehicle communication and alert processor 250. The vehicle communication and alert processor 250 include one or more processors and may be in communication with various communication devices such as screens, audio, as well as, other indicators within the vehicle to alert and/or communicate certain items of information with the occupant of the vehicle. The vehicle may include a video display 252 that may be part of the instrument cluster or part of the vehicle entertainment system. An indicator 254 which may also be part of the instrument cluster or may take the form of a heads-up or windshield projector indicator. In addition, the system may provide stimulus to the occupant through an indicator on the rearview mirror 256 or the side mirror 258. Further, communication may be provided between the system and the occupant through audio. For example, a speaker 260 and a microphone 262 may provide sound indicators or verbal communication between the occupant and the system 250.

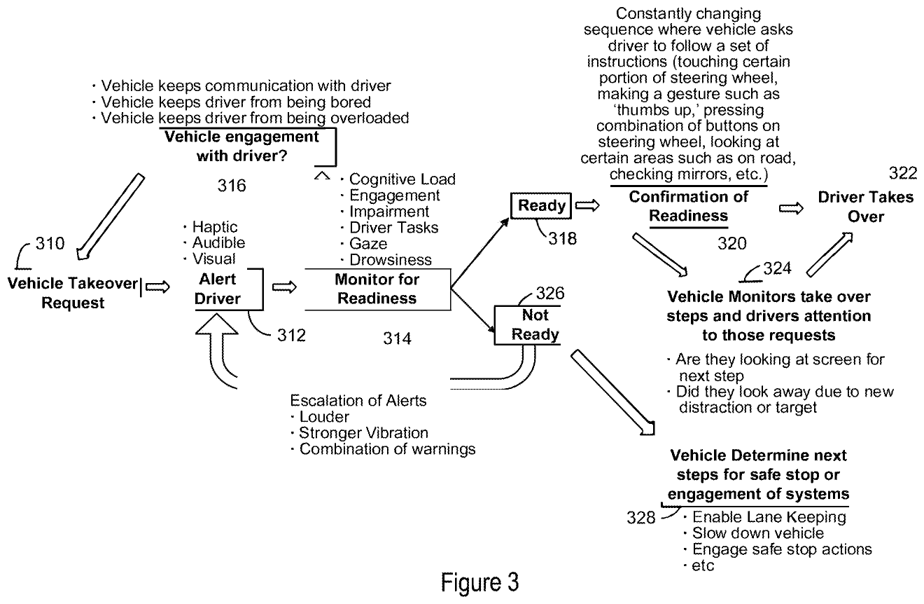

FIG. 3 is a schematic diagram illustrating a method for detecting driver readiness for vehicle takeover requests. In block 310, the vehicle initiates a takeover request. In block 312, an alert is provided to the driver. The alert may be provided to the driver through an occupant communication and alert system such as, for example, using the communication and alert processor 250. As such, the alert may be haptic, audible, visual, or other type of alert. In block 314, the system monitors the driver for readiness of takeover. The driver readiness of takeover may be evaluated based on various driver attributes which may be measured by one or more driver monitoring sensors of a driver monitor system as discussed elsewhere in this application. The driver readiness evaluation may be based on attributes such as cognitive load, engagement of the driver, impairment of the driver, driver tasks (driver eating, driver drinking, driver adjusting radio), driver's gaze (direction, length), drowsiness, etc. As denoted in block 316, the system may actively engage with the driver in advance of vehicle takeover or in advance of vehicle takeover requests such that the driver will be engaged with the driving of the vehicle prior to the need of the driver taking over the vehicle. The vehicle's engagement may provide regular communication with the driver, for example, letting the driver know about possible events and/or the pending driver takeover. The engagement may include the vehicle keeping the driver from being bored for example, on long drives or from the driver being overloaded from getting other input and being able to focus on the takeover request task. The engagement may include verbal questions, chimes, or other visual indications. As the vehicle driver is engaged, the system may again initiate the vehicle takeover request as denoted by block 310. If the driver is ready for vehicle takeover in block 314, the method proceeds to block 318. In block 320, the driver readiness is confirmed. This confirmation may be an active confirmation requiring the driver to take a specific action. The confirmation may be a constantly changing sequence where the vehicle has to drive or to follow a set of instructions. For example, the instructions may include touching certain portions of the steering wheel, and/or making a gesture such as a thumbs up. The sequence may also include things such as pressing a combination of buttons on the steering wheel, looking at certain areas such as on road, checking mirrors, etc. If there is a confirmation of readiness in block 320, the driver takes over as denoted by block 322. The driver takeover may be confirmed with the driver for example, through a verbal notice such as “driver takeover sequence complete”. If a confirmation of readiness is not received, the vehicle monitors takeover steps and the driver's attention to those requests as denoted by block 324. This may include determining whether the driver is looking at the screen for the next step and/or determining if the driver looked away due to a new distraction or new target. Once the confirmation of readiness is complete, the driver takes over as denoted by block 322. If the driver is not ready in block 314, the method proceeds to block 326. The method may branch into different steps depending on external variables such as the reason for the takeover request, pending objects, speed of the vehicle, etc. In some conditions, the system may escalate the alerts to the driver for example, by making the alerts louder, or stronger vibrations, or a combination of various warnings for example, both visual and audio alerts in conjunction. The escalation of the alerts is accomplished in block 312 and the process continues to monitor the readiness as denoted in block 314. In another instance, based on the external conditions, the process may go from block 326 to block 328 where the vehicle determines the next steps for a safe stop or engagement of other systems. This may include enabling a lane keeping system, slowing down the vehicle, or engaging safe stop actions. In some implementations, it may include reengaging an autonomous driving system.

A method for determining driver readiness for takeover vehicle control from an autonomous driving system is also provided. The method includes capturing, by at least one driver monitoring sensor, an attribute of the driver indicative of driver ability to take over vehicle control. The attribute indicative of the driver ability to take over vehicle control may include, for example, cognitive load, driver engagement, driver drowsiness, driver impairment, driver tasks, and/or a gaze direction that the driver is looking.

The method also includes generating, by a driver monitoring system, driver data using sensor data from the at least one driver monitoring sensor. The driver monitor data may include, for example, computed values regarding one or more attributes indicative of driver ability to take over vehicle control.

The method proceeds with determining, by an evaluation processor, driver ability to take over vehicle control using the driver data from the driver monitoring system. This step may include, for example comparing the driver monitor data against one or more predetermined benchmark values or conditions that correspond to the driver being ready and able to take over vehicle control.

The method may also include the steps of: prompting the driver to perform an affirmative confirmation of readiness in response to a takeover request from the autonomous driving system; and determining performance of the affirmative confirmation of readiness using the driver data from the driver monitoring system. This step may include recognizing a gesture or a verbal response by the driver. Alternatively or additionally, this step may include determining performance of an action by the driver using a user interface, such as a button press or a particular interaction with a touchpad or a touch screen. This step of determining performance of the affirmative confirmation may be performed by the evaluation processor. In some embodiments, this step of determining performance of the affirmative confirmation may be performed by another system or controller, such as an infotainment system in cases where the affirmative confirmation requires interaction with the infotainment system.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of the principles of this application. This description is not intended to limit the scope or application of the claim in that the assembly is susceptible to modification, variation and change, without departing from spirit of this application, as defined in the following claims.

In The Claims:

1. A monitoring system for determining driver readiness for takeover vehicle control from an autonomous driving system, the monitoring system comprising:
a driver monitoring system comprising at least one driver monitoring sensor configured to capture an attribute of the driver indicative of driver ability to take over vehicle control;
an evaluation processor configured to access driver data from the driver monitoring system and to determine driver ability to take over vehicle control using the driver data from the driver monitoring system;
wherein the at least one driver monitoring sensor comprises a camera positioned such that the driver is in a field of view of the camera;
wherein the evaluation processor is further configured to prompt the driver to perform an affirmative confirmation of readiness in response to a takeover request from the autonomous driving system; and
wherein the evaluation processor is further configured to detect the affirmative confirmation of readiness using the camera.

2. (canceled)

3. (canceled)

4. The system of claim 1, wherein the evaluation processor is further configured to determine performance of the affirmative confirmation of readiness using the driver data from the driver monitoring system.

5. The system of claim 1, wherein the affirmative confirmation comprises a sequence of requested actions.

6. The system of claim 5, wherein the sequence of requested actions changes over time.

7. The system of claim 1, wherein the evaluation processor is configured to determine the driver ability to take over vehicle control based on one of cognitive load, driver engagement, driver drowsiness, driver impairment, or driver tasks.

8. The system of claim 1, wherein the evaluation processor is configured to determine the driver ability to take over vehicle control based on a gaze direction that the driver is looking.

9. The system of claim 1, wherein the evaluation processor is configured to engage the driver to maintain a threshold level of ability to take over the vehicle.

10. The system of claim 1, wherein the evaluation processor is configured to engage the driver through a verbal query.

11. The system of claim 10, wherein the evaluation processor is configured to determine, using the at least one driver monitoring sensor, whether the driver responded to the verbal query.

12. The system of claim 11, wherein the at least one driver monitoring sensor includes a microphone, and wherein the evaluation processor is configured to determine a verbal response to the verbal query.

13. The system of claim 11, wherein the at least one driver monitoring sensor includes a camera positioned such that the driver is in a field of view of the camera, and wherein the evaluation processor is configured to determine a gesture response by driver to the verbal query.

14. The system of claim 1, wherein the evaluation processor is configured to generate an alert to the driver in response to determining the driver not being able to take over vehicle control.

15. The system of claim 14, wherein the alert includes a plurality of alerts having increasing volume or intensity over time and until the driver responds to the alert.

16. The system of claim 1, further comprising an external sensor configured to monitor an environment surrounding the vehicle, wherein the evaluation processor is configured to determine an external environment attribute using the external sensor and to initiate a driver takeover request from an autonomous driving system in response to the external environment attribute; and
wherein the evaluation processor is configured to perform an alternative action in response to determining that the driver is not ready for takeover of the vehicle and with distance or timing related to the external environment attribute is below a threshold.

17. The system of claim 16, wherein the evaluation processor determines the alternative action comprises at least one of enable lane keeping, slow down the vehicle, and engage safe stop actions.

18. A method for determining driver readiness for takeover vehicle control from an autonomous driving system, the method comprising:
capturing, by at least one driver monitoring sensor, an attribute of the driver indicative of driver ability to take over vehicle control, the at least one driver monitoring sensor including a camera positioned such that the driver is in a field of view of the camera;
generating, by a driver monitoring system, driver data using sensor data from the at least one driver monitoring sensor;
determining, by an evaluation processor, driver ability to take over vehicle control using the driver data from the driver monitoring system;
prompting the driver to perform an affirmative confirmation of readiness in response to a takeover request from the autonomous driving system; and
detecting the affirmative confirmation of readiness using the camera.

19. (canceled)

20. The method of claim 18, wherein determining, by the evaluation processor, the driver ability to take over vehicle control using the driver data from the driver monitoring system further comprises determining the driver ability to take over vehicle control based on one of cognitive load, driver engagement, driver drowsiness, driver impairment, driver tasks, or a gaze direction that the driver is looking.

21. The method of claim 18, wherein the affirmative confirmation of readiness includes at least one of a gesture performed by the driver or the driver looking in sequence of different directions.

22. The system of claim 1, wherein the affirmative confirmation of readiness includes a gesture performed by the driver.

23. The system of claim 1, wherein the affirmative confirmation of readiness includes the driver looking in sequence of different directions.
